(19) United States
(12) Patent Application Publication
(10) Pub. No.: US 2020/0182163 A1
(43) Pub. Date: Jun. 11, 2020

(54) CONTROL DEVICE FOR INTERNAL COMBUSTION ENGINE

(71) Applicant: AISIN SEIKI KABUSHIKI KAISHA, Kariya-shi, Aichi-ken (JP)

(72) Inventors: Seiichi FUJIMOTO, Chiryu-shi, Aichi-ken (JP); Masaaki KANEKO, Nukata-gun, Aichi-ken (JP); Hirokazu TANAKA, Nagoya-shi, Aichi-ken (JP)

(73) Assignee: AISIN SEIKI KABUSHIKI KAISHA, Kariya-shi, Aichi-ken (JP)

(21) Appl. No.: 16/614,933

(22) PCT Filed: Feb. 28, 2018
(86) PCT No.: PCT/JP2018/007440

§ 371 Date: Nov. 19, 2019

(30) Foreign Application Priority Data
May 23, 2017 (JP) 2017-102039

(51) Int. Cl. F02D 13/02

(52) U.S. Cl. CPC F02D 13/0219; F02N 11/00; F02D 2200/70; F02D 13/0265

(57) ABSTRACT

The internal combustion engine includes: a plurality of cylinders each including a piston that reciprocally operates in association with rotation of a crankshaft, and an intake valve and an exhaust valve that open and close a combustion chamber; a starter motor that drives and rotates the crankshaft; and a valve opening-closing timing control mechanism that sets opening and closing timings of the exhaust valve by driving an electric actuator. If an environmental temperature detected by an environmental temperature sensor is less than 10 degrees below freezing, the control device controls the electric actuator such that the closing timing of the exhaust valve is made different from a top dead center of the piston, at a point in time when cranking is performed, and an initial combustion in one of the plurality of cylinders that is set to be the cylinder in which combustion is performed first is performed.

### TECHNICAL FIELD

The present invention relates to a control device for an internal combustion engine.

### BACKGROUND ART

PTL 1 describes a technique including an exhaust-side variable valve timing mechanism and an intake-side variable valve timing mechanism, wherein an intake valve and an exhaust valve are controlled in a negative overlap state under low temperatures, and the negative overlap state is prohibited if an electronic throttle failure occurs.

PTL 1 describes a control mode in which the opening and closing timings of an exhaust valve are advanced for the purpose of improving the startability at the time of a cold start and reducing the exhaust emission, and the exhaust valve is closed before the exhaust top dead center (TDC). In particular, the valve timing mechanism of PTL 1 is configured hydraulically, and receives hydraulic fluid supplied from a hydraulic pump that is driven by the engine.

PTL 2 describes a variable valve mechanism technique including a variable valve as at least one of an intake valve and an exhaust valve, wherein blowback of the exhaust gas is performed by controlling the variable valve from the beginning to after the start of an internal combustion engine.

PTL 2 describes that blowback of the exhaust gas is performed through negative overlap in which the intake valve and the exhaust valve are set to simultaneously enter a closed state, thus atomizing the injected fuel. PTL 2 also describes that the responsivity of the valve timing control using either a hydraulic variable valve mechanism or an electric variable valve mechanism is reduced in the case of performing control to advance the closing of the exhaust valve during a low-temperature, low-speed operation immediately after the start.

### CITATION LIST

### Patent Literature

PTL 1: JP 2008-274822A

PTL 2: JP 2009-216034A

### SUMMARY OF INVENTION

### Technical Problem

For a reciprocal internal combustion engine, it is conceivable to improve the startability by setting an overlap amount between the intake valve and the exhaust valve when the internal combustion engine is started in a cold-temperature state, as is also described in PTLs 1 and 2. However, in the case of using a hydraulically operated valve opening-closing timing control mechanism for the intake valve and the exhaust valve, the mechanism cannot be expected to operate properly due to high viscosity of the hydraulic fluid in an environment in a cold-temperature state. Moreover, in the case of using a valve opening-closing timing control mechanism to which the hydraulic fluid is supplied using the driving force of the internal combustion engine, it is difficult for the mechanism to perform operations required during cranking.

In addition to being required to have good startability when starting in a relatively warm environment, internal combustion engines are also required to have good startability in an extremely-cold environment at a temperature of less than 10 degrees below freezing, and there is still room for improvement in this respect.

For this reason, there is need for a control device capable of satisfactorily starting an internal combustion engine even in a very-low temperature environment. Solution to Problem

A characteristic feature of the present invention lies in a control device for an internal combustion engine,

the internal combustion engine including: a plurality of cylinders each including a piston that reciprocally operates within a cylinder in association with rotation of a crankshaft, and an intake valve and an exhaust valve that open and close a combustion chamber in association with rotation of the crankshaft; a starter motor that drives and rotates the crankshaft; and a valve opening-closing timing control mechanism that sets opening and closing timings of the exhaust valve by driving an electric actuator, the control device including:

an environmental temperature sensor for detecting an environmental temperature around the internal combustion engine,

wherein, if the environmental temperature detected by the environmental temperature sensor is less than 10 degrees below freezing, the control device controls the electric actuator such that EVC, which is a closing timing of the exhaust valve, is made different from TDC, which is a top dead center of the piston in the combustion chamber, in a situation where cranking is performed by the starter motor, at a point in time when an initial combustion in one of the plurality of cylinders that is set to be the cylinder in which combustion is performed first is performed.

According to this characteristic feature, in a situation where cranking is started by the starter motor in a very-low temperature environment at a temperature of less than 10 degrees below freezing, the valve opening-closing timing control mechanism is operated by the driving of the electric actuator, at a point in time when an initial combustion in one of the plurality of cylinders that is set to be the cylinder in which combustion is performed first is performed. With this operation, for example, by setting EVC, which is the closing timing of the exhaust valve, to ATDC after TDC, which is a top dead center of the piston, it is possible to increase the temperature in the combustion chamber through internal EGR using overlap. Conversely, by setting EVC to BTDC, which is before TDC, it is possible to increase the temperature by temporarily trapping combustion gas using negative overlap.

That is, by controlling the electric actuator, the opening and closing timings of the exhaust valve can be freely set by the opening-closing timing control mechanism even at a very low temperature, and the amount of taken-in air will not be changed even if the opening and closing timings of the exhaust valve are set in this manner. Furthermore, with this configuration, the valve opening-closing timing control mechanism sets the opening and closing timings of the exhaust valve using the driving force of the electric actuator, and it is thus possible to set the closing timing to a timing immediately after cranking has started, in contrast to a configuration that is operated hydraulically.

Accordingly, a control device capable of satisfactorily starting the internal combustion engine even in a very-low temperature environment has been configured. According to another configuration, at a point in time when an initial combustion in one of the plurality of cylinders that is set to be the cylinder in which combustion is performed first is performed, an overlap in which the EVC and IVO, which is opening timing of the intake valve, are overlapped may be set by setting the EVC to ATDC, which is after the TDC.

With this configuration, through internal EGR in which an overlap is created between the exhaust valve and the intake valve and part of combustion gas is taken into the combustion chamber in an intake stroke, the temperature of the inner wall is increased by bringing the combustion gas into contact with the inner wall of the piston, thus achieving satisfactory starting of the internal combustion engine at a very low temperature.

According to another configuration, an amount of the overlap may be reduced after the number of revolutions of the crankshaft exceeds a predetermined set value.

With this configuration, the overlap amount is reduced after combustion has been started in the combustion chamber, and it is thus possible to perform stable combustion by suppressing the effect of the combustion gas.

According to another configuration, at a point in time when an initial combustion in one of the plurality of cylinders that is set to be the cylinder in which combustion is performed first is performed, a negative overlap may be set between the EVC and IVO, which is an opening timing of the intake valve, by setting the EVC to BTDC, which is before the TDC.

With this configuration, by creating a negative overlap, the combustion gas in a combustion stroke is temporarily trapped in the combustion chamber so as to increase the temperature of the cylinder inner wall and the like of the combustion chamber, thus achieving satisfactory starting of the internal combustion engine at a very low temperature.

According to another configuration, an amount of the negative overlap may be reduced after the number of revolutions of the crankshaft exceeds a predetermined value.

With this configuration, the negative overlap amount is reduced after combustion has been started in the combustion chamber, and it is thus possible to perform the required combustion by increasing the amount of taken-in air in an intake stroke.

According to another configuration, at a point in time when an initial combustion in one of the plurality of cylinders that is set to be the cylinder in which combustion is performed first is performed, the control device may control the electric actuator such that an overlap is set by retarding the EVC relative to IVO, which is an opening timing of the intake valve.

With this configuration, it is possible to create an overlap by retarding EVC, which is the closing timing of the exhaust valve, relative to IVO, which is the opening timing of the intake valve.

### BRIEF DESCRIPTION OF DRAWINGS

FIG. 1 is a diagram showing a cross section of an engine, and a control unit.

FIG. 2 is a cross-sectional view of a valve opening-closing timing control mechanism.

FIG. 3 is a cross-sectional view taken along the line III-III in FIG. 2.

FIG. 4 is a cross-sectional view taken along the line IV-IV in FIG. 2.

FIG. 5 is an exploded perspective view of the valve opening-closing timing control mechanism.

FIG. 6 is a flowchart of a starting routine.

FIG. 7 is a flowchart of a first very-low temperature starting routine.

FIG. 8 is a timing diagram showing an overlap state.

FIG. 9 is a timing diagram showing a state in which overlap is eliminated.

FIG. 10 is a flowchart of a second very-low temperature starting routine.

FIG. 11 is a timing diagram showing a negative overlap state.

FIG. 12 is a timing diagram showing a state in which negative overlap is eliminated.

FIG. 13 is a chart showing a relationship between the number of engine revolutions and overlap.

### Description of Embodiments

Hereinafter, an embodiment of the present invention will be described with reference to the drawings.

### [Basic Configuration]

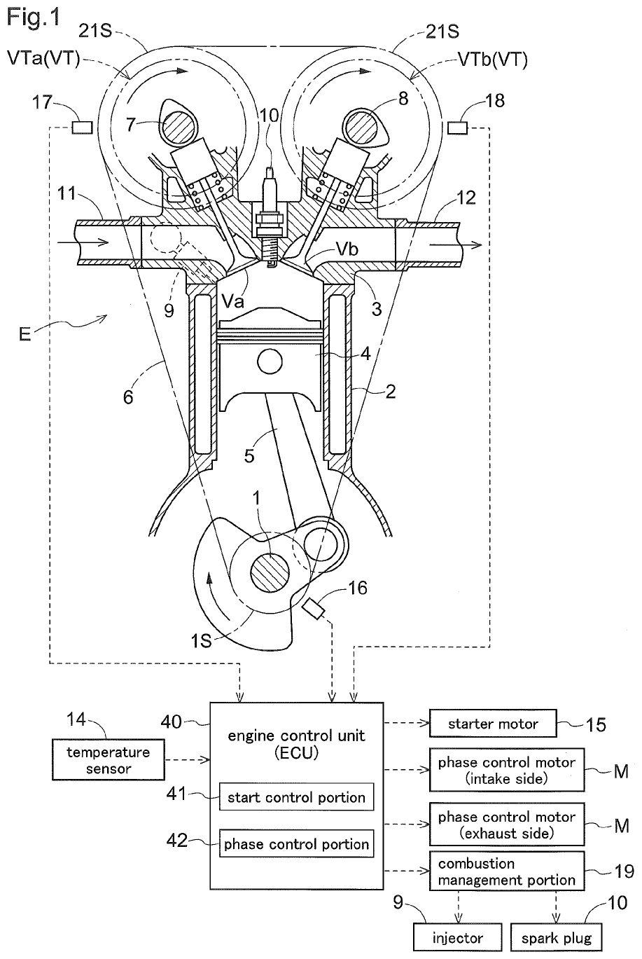

As shown in FIG. 1, an engine control device 40 is configured that functions as an ECU so as to control an intake-side valve opening-closing timing control mechanism VTa for setting opening and closing timings of an intake valve Va of an engine E functioning as an internal combustion engine, an exhaust-side valve opening-closing timing control mechanism VTb for setting opening and closing timings of an exhaust valve Vb, and the engine E.

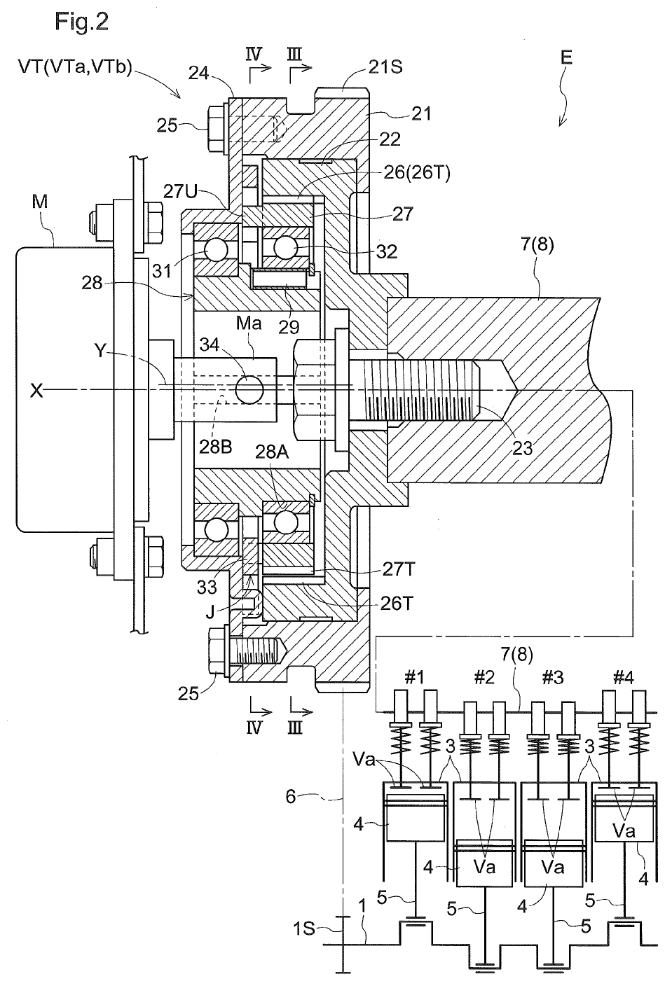

The engine E (an example of the internal combustion engine) shown in FIGS. 1 and 2 is assumed to be provided in a vehicle such as a passenger car. The engine E is configured as a four-cycle engine by coupling a cylinder head 3 to an upper portion of a cylinder block 2 that supports a crankshaft 1, slidably housing pistons 4 in a plurality of cylinder bores formed in the cylinder block 2, and coupling the pistons 4 to the crankshaft 1 using connecting rods 5.

In the engine E, #1 cylinder, #2 cylinder, #3 cylinder, and #4 cylinder (indicated as #1, #2, #3, and #4 in FIG. 2) are disposed from one end portion toward the other end portion of the engine E, and a combustion chamber is formed between the piston 4 and the cylinder head 3 in the internal space of each cylinder.

Each cylinder head 3 includes an intake valve Va that is opened when air is taken into the combustion chamber and an exhaust valve Vb that is opened when combustion gas is discharged from the combustion chamber, and an intake camshaft 7 that controls the intake valves Va and an exhaust camshaft 8 that controls the exhaust valves Vb are provided above the cylinder heads 3. A timing chain 6 is wound around an output sprocket 1S of the crankshaft 1 and sprockets 21S of driving cases 21 of the intake-side valve opening-closing timing control mechanism VTa and the exhaust-side valve opening-closing timing control mechanism VTb.

Additionally, the cylinder head 3 includes an injector 9 that injects fuel into the combustion chamber, and a spark plug 10. An intake manifold 11 for supplying air to the combustion chambers via the intake valves Va and an exhaust manifold 12 for expelling combustion gas from the combustion chamber via the exhaust valves Vb are coupled to the cylinder heads 3.

The engine E includes a starter motor 15 that drives and rotates the crankshaft 1, and a shaft sensor 16 for detecting the rotation angle and the rotation speed (the number of revolutions per unit hour) is provided at a position in the vicinity of the crankshaft 1. An intake-side phase sensor 17 for detecting the relative rotational phase between the driving case 21 and the internal rotor 22 is provided in the vicinity of the intake-side valve opening-closing timing control mechanism VTa, and an exhaust-side phase sensor 18 for detecting the relative rotational phase between the driving case 21 and the internal rotor 22 is provided in the vicinity of the exhaust-side valve opening-closing timing control mechanism VTb.

The engine E includes a temperature sensor 14 (an example of an environmental temperature sensor) for detecting the water temperature of cooling water in a water jacket. The temperature sensor 14 is used for control to manage the water temperature while the engine E is running. In the engine control device 40, the temperature sensor 14 is used to detect the surrounding environmental temperature and also to set the opening and closing timings of the valves when the engine E is started. A sensor for detecting the temperature of a space that is distanced from the engine E, such as a sensor for detecting the temperature inside the engine room of a vehicle, may be used as the temperature sensor 14 (environmental temperature sensor).

Note that the engine E includes a cylinder determination unit (not shown) that determines a cylinder in which combustion is to be performed, and a part of the configuration of the cylinder determination unit constitutes the shaft sensor 16.

The engine control device 40 functions as an ECU that controls the engine E, and includes a start control portion 41 and a phase control portion 42. The start control portion 41 controls starting of the engine E. The phase control portion 42 controls the relative rotational phase between the intake-side valve opening-closing timing control mechanism VTa and the exhaust-side valve opening-closing timing control mechanism VTb. The details and the control modes of the engine control device 40 will be described later.

### [Valve Opening-Closing Timing Control Mechanism]

Since the intake-side valve opening-closing timing control mechanism VTa and the exhaust-side valve opening-closing timing control mechanism VTb have the same configuration, the broader concept thereof will be referred to as “valve opening-closing timing control mechanism VT”. The valve opening-closing timing control mechanism VT controls the opening and closing timings of the corresponding valves by using the driving force of a phase control motor M as an electric actuator.

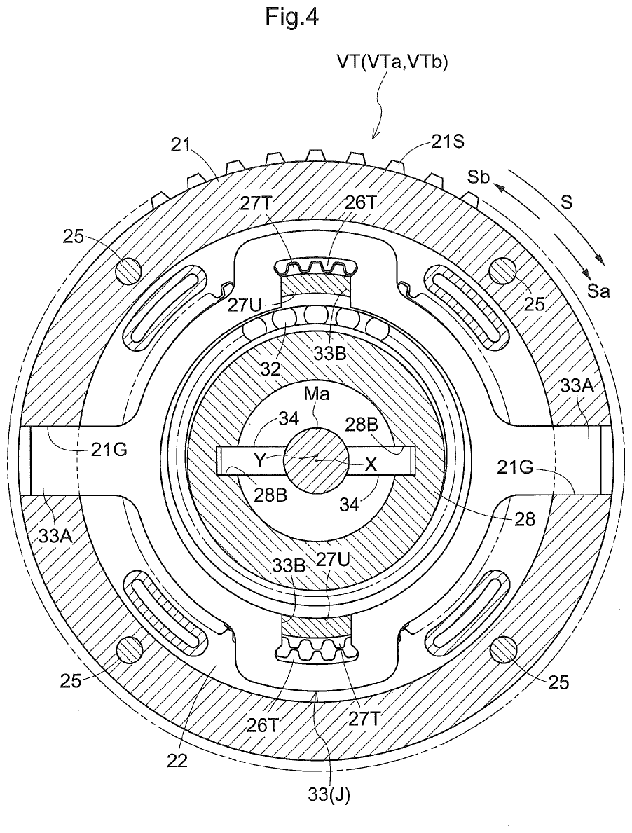

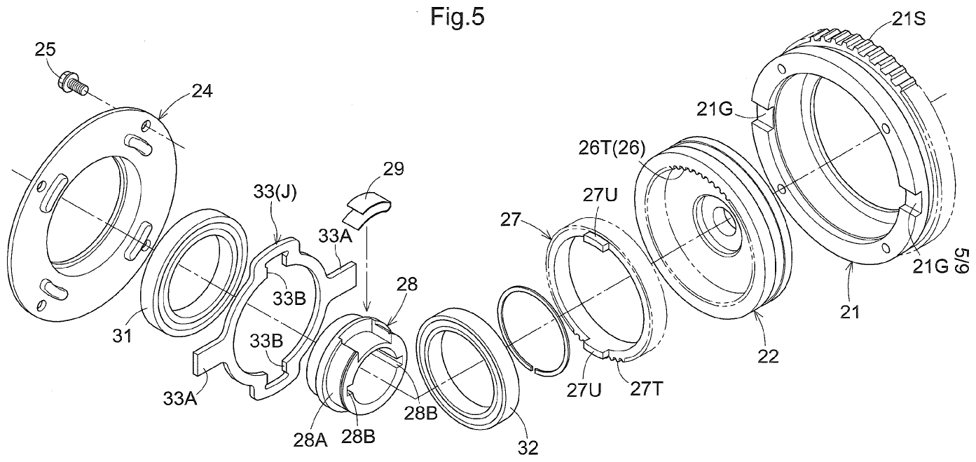

FIGS. 2 to 5 show the intake-side valve opening-closing timing control mechanism VTa. The valve opening-closing timing control mechanism VTa includes a driving case 21 and an internal rotor 22, and also includes a phase adjustment portion that sets the relative rotational phase between the driving case 21 and the internal rotor 22 by using the driving force of the phase control motor M.

The driving case 21 has a sprocket 21S formed on the outer circumference thereof, and is disposed coaxially with a rotation axis X of the intake camshaft 7. The internal rotor 22 is enclosed so as to be relatively rotatable with respect to the driving case 21, and is coupled and fixed to the intake camshaft 7 by a coupling bolt 23. The phase adjustment portion is disposed between the driving case 21 and the internal rotor 22. A front plate 24 is disposed at a position where it covers the opening portion of the driving case 21, and is fastened to the driving case 21 by a plurality of fastening bolts 25. Note that the internal rotor 22 is coupled to the exhaust camshaft 8 in the exhaust-side valve opening-closing timing control mechanism VTb.

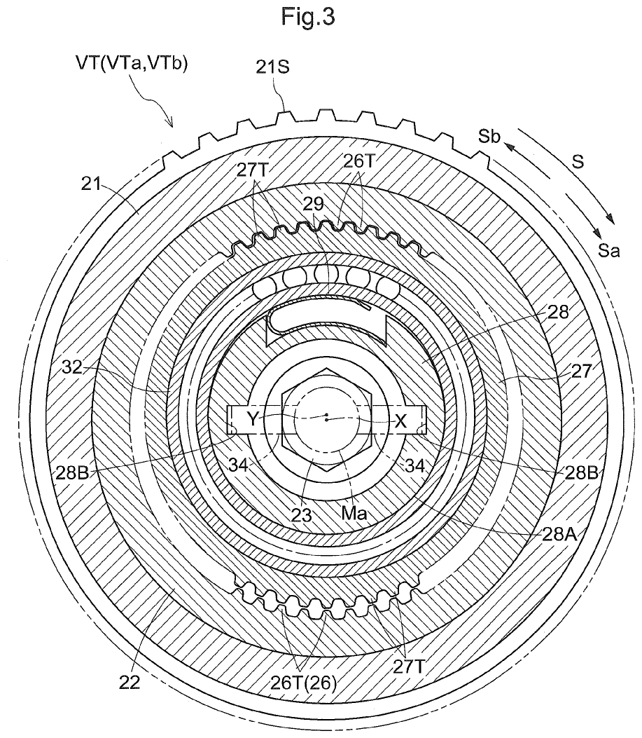

As shown in FIG. 3, the valve opening-closing timing control mechanism VTa is rotated as a whole in a drive rotation direction S by the driving force from the timing chain 6. A direction in which the relative rotational phase of the internal rotor 22 with respect to the driving case 21 is displaced in the same direction as the drive rotation direction S by the driving force of the phase control motor M is referred to as “advancing direction Sa”, and displacement in a direction opposite to this direction is referred to as “retarding direction Sb”.

### [Valve Opening-Closing Timing Control Mechanism: Phase Adjustment Portion]

As shown in FIGS. 2 to 5, the phase adjustment portion includes a ring gear 26 disposed coaxially with the rotation axis X with a plurality of internal teeth portions 26T formed integrated with the inner circumferential surface of the internal rotor 22, an inner gear 27 disposed coaxially with an eccentric axis Y in an orientation parallel to the rotation axis X with a plurality of external teeth portions 27T for meshing with the ring gear 26, an eccentric cam body 28, and a joint portion J.

In the phase adjustment portion, an inner gear 27 having the number of external teeth portions 27T that is fewer by one than the number of internal teeth portions 26T of the ring gear 26 is used.

The joint portion J is configured as an Oldham coupling that allows the internal rotor 22 to be displaced relative to the driving case 21 in a direction orthogonal to the rotation axis X, while preventing relative rotation between the driving case 21 and the internal rotor 22.

The eccentric cam body 28 is supported by a first bearing 31 relative to the front plate 24 so as to rotate coaxially with the rotation axis X. An eccentric cam surface 28A centered around the eccentric axis Y in an orientation parallel to the rotation axis X is formed integrated with the eccentric cam body 28, and the inner gear 27 is rotatably supported relative to the eccentric cam surface 28A via a second bearing 32. A spring body 29 is fitted into a recess formed in the eccentric cam surface 28A, and the biasing force of the spring body 29 is exerted on the inner gear 27 via the second bearing 32.

The eccentric cam body 28 has an overall tubular shape, and a pair of engaging grooves 28B are formed in the inner circumferential surface thereof in an orientation parallel to the rotation axis X.

Consequently, some of the external teeth portions 27T of the inner gear 27 mesh with some of the internal teeth portions 26T of the ring gear 26. Although the first bearing 31 and the second bearing 32 are formed by ball bearings, they may be formed by bushes.

The joint portion J includes a joint member 33 formed by pressing a plate material. The joint portion J is configured by engaging a pair of engaging arms 33A formed on the joint member 33 with engaging groove portions 21G of the driving case 21, and engaging a pair of engaging recesses 33B formed in the joint member 33 with engaging protrusions 27U of the inner gear 27.

That is, the joint member 33 is formed so that the central part thereof has an annular shape, and has a structure in which a pair of engaging arms 33A are formed protruding outward from the annular central part, and a pair of engaging recesses 33B are formed continuously with the space of the annular central part.

In the joint portion J, the joint member 33 is displaceable in a direction of a straight line connecting the pair of engaging grooves portion 21G of the driving case 21, and the inner gear 27 is displaceable, relative to the joint member 33, in a direction of a straight line connecting the pair of the engaging protrusions 27U.

The phase control motor M (see FIG. 2) is supported by the engine E, and includes an engaging pin 34 provided in an orientation orthogonal to an output shaft Ma. The engaging pin 34 is fitted into the engaging grooves 28B in the inner circumferential surface of the eccentric cam body 28. Although a brushless DC motor is used as the phase control motor M, a synchronous motor such as a stepping motor may also be used.

Accordingly, considering an operation mode in a state in which the engine E is stopped, when the eccentric cam body 28 is rotated by the driving force of the phase control motor M, the eccentric cam surface 28A is rotated about the rotation axis X. With this rotation, the inner gear 27 starts revolving about the rotation axis X. During this revolving, the meshing positions between the external teeth portions 27T of the inner gear 27 and the internal teeth portions 26T of the ring gear 26 are displaced along the inner circumferential surface of the ring gear 26, and, therefore, a force to rotate the inner gear 27 about the eccentric axis Y acts on the inner gear 27.

That is, when the inner gear 27 makes only one revolution, a rotational force (self-rotation force) to rotate the inner gear 27 by an angle (angle corresponding to one tooth) corresponding to the difference (teeth number difference) between the number of internal teeth portions 26T of the ring gear 26 and the number of external teeth portions 27T of the inner gear 27 acts on the inner gear 27.

As previously described, the joint portion J is a structure that restricts the rotation of the inner gear 27 relative to the driving case 21. Accordingly, without the inner gear 27 being rotated relative to the driving case 21, the rotational force acting on the inner gear 27 causes the ring gear 26 to rotate relative to the driving case 21. Consequently, the internal rotor 22 is relatively rotated together with the ring gear 26, thus achieving adjustment of the rotational phase of the intake camshaft 7 relative to the driving case 21.

In particular, when the inner gear 27 makes one revolution about the rotation axis X, adjustment is achieved with a high speed reduction ratio, since the intake camshaft 7 is rotated relative to the driving case 21 by an angle corresponding to the difference (teeth number difference) between the number of the external teeth portions 27T of the inner gear 27.

### [Valve Opening-Closing Timing Control Mechanism: Outline of Phase Adjustment]

Taking phase adjustment using the intake-side valve opening-closing timing control mechanism VTa as an example, the phase control portion 42 of the engine control device 40 maintains the relative rotational phase between the driving case 21 and the internal rotor 22 by driving and rotating the output shaft Ma of the phase control motor M in the same direction and at the same rotation speed as the intake camshaft 7.

The relative rotational phase is displaced in the advancing direction Sa or the retarding direction Sb by increasing or decreasing the rotation speed of the phase control motor M relative to the rotation speed of the intake camshaft 7. The displacement direction (one of the advancing direction Sa and the retarding direction Sb) of the relative rotational phase for increasing or decreasing the rotation speed of the phase control motor M is determined by the gear configuration of the phase adjustment portion.

In particular, the valve opening-closing timing control mechanism VT displaces the relative rotational phase by using the driving force of the phase control motor M. This enables operations at a higher speed as compared with displacement achieved with hydraulic pressure. In a situation where hydraulic pressure is insufficient, for example, when starting the engine E, the required rotational phase can be promptly set. Note that the valve opening-closing timing control mechanism VT may control the opening and closing timings of the corresponding valve by using the driving force of an actuator such as an electric motor, and therefore is not limited to the structure described in the embodiment.

### [Control Structure]

As shown in FIG. 1, the engine control device 40 receives input of detection signals from the temperature sensor 14, the shaft sensor 16, the intake-side phase sensor 17, and the exhaust-side phase sensor 18, and outputs control signals to the intake-side and exhaust-side phase control motors M and the starter motor 15. Furthermore, the engine control device 40 outputs control signals to a combustion management portion 19 that controls the injector 9 and the spark plug 10.

The start control portion 41 achieves cranking by controlling the starter motor 15. The phase control portion 42 can set the opening and closing timings of the intake valve Va and the opening and closing timings of the exhaust valve Vb by controlling the phase control motor M of the intake-side valve opening-closing timing control mechanism VTa and the phase control motor M of the exhaust-side valve opening-closing timing control mechanism VTb.

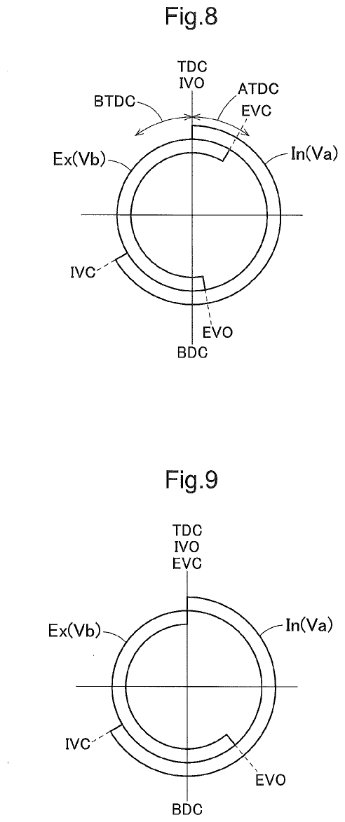

As shown in FIGS. 8, 9, 11, and 12, in the description of the following control, a direction in which IVO, which is the opening timing of the intake valve Va, and EVO, which is the opening timing of the exhaust valve Vb, are advanced is referred to as “advancing direction” (advancing side), and the direction opposite thereto is referred to as “retarding direction” (retarding side).

Although the start control portion 41 and the phase control portion 42 of the engine control device 40 are assumed to be configured by software, these may be configured by hardware formed by a circuit including a logic circuit or the like, or may be configured by a combination of software and hardware.

The combustion management portion 19 manages operations of pumps and the like that supply fuel to the injector 9, and manages the ignition order and the ignition timing by controlling an ignition circuit that supplies power to the spark plug 10.

### [Control Mode]

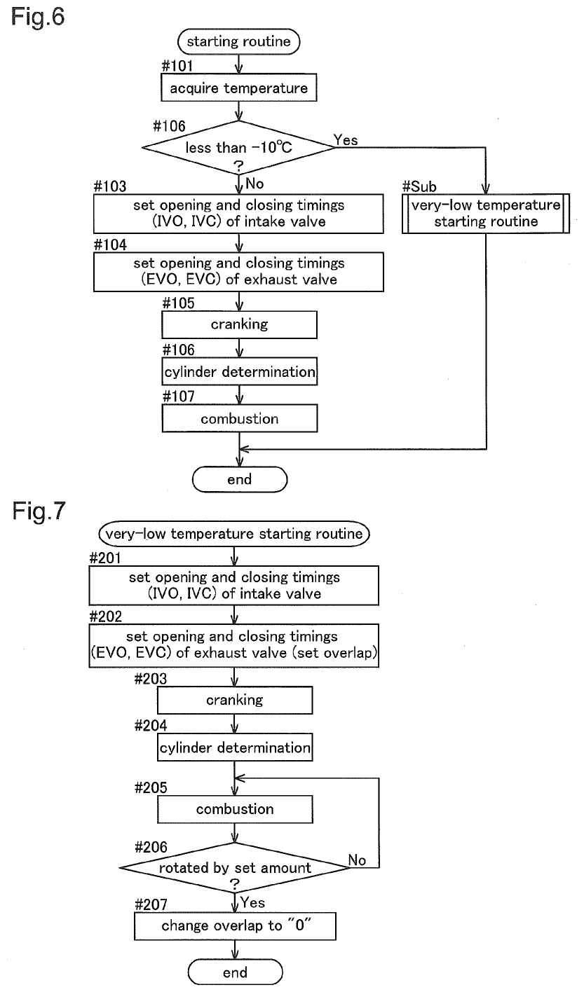

When a control signal for starting the engine E is acquired from the above-described configuration, the start control portion 41 of the engine control device 40 performs the following control, as shown in the flowchart in FIG. 6 and the timing diagrams in FIGS. 8, 9, etc.

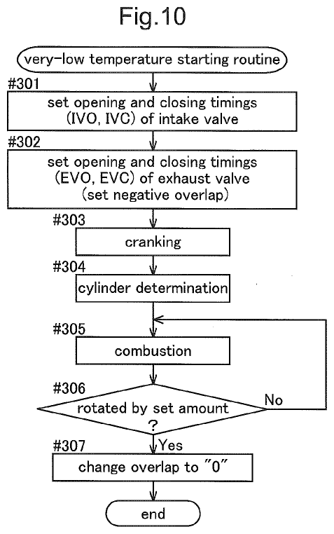

That is, the environment temperature is acquired from a detection signal of the temperature sensor 14 (steps #101 and #102). If it is detected that the temperature is less than 10 degrees below freezing (less than −10° C.), the procedure proceeds to a very-low temperature starting routine(#Sub) shown in FIG. 7 or 10.

Although the control mode in the very-low temperature starting routine (#Sub) will be described later, if it is determined that the temperature detected by the temperature sensor 14 is greater than or equal to 10 degrees below freezing (greater than or equal to −10° C.), the opening and closing timings of the intake valve Va are set by control performed by the intake-side valve opening-closing timing control mechanism VTa, and the opening and closing timings of the exhaust valve Vb are set by control performed by the exhaust-side valve opening-closing timing control mechanism VTb (steps #103 and #104).

In steps #103 and #104, control is performed such that IVO, which is the opening timing of the intake valve Va, and EVC, which is the closing timing of the exhaust valve Vb, are matched with TDC, which is a top dead center of the piston 4, as shown in the timing diagram in FIG. 9. In FIG. 9, an area in which air exhaustion is performed by the exhaust valve Vb is indicated as exhaust area Ex, and an area in which air intake is performed by the intake valve Va is indicated as intake area In. Note that, through control to displace IVO, which is the opening timing of the intake valve Va, in the advancing direction as the opening/closing timing, a slight overlap may be set between IVO and EVC.

Next, cranking is started in response to driving of the starter motor 15, then cylinder determination is performed, and the combustion management portion 19 starts combustion in the combustion chambers in a set order at a predetermined timing and rotation speed (number of revolutions per unit time) of the crankshaft 1 (steps #105 to #107). Then, the starter motor 15 is stopped after combustion has been started in all of the cylinders.

### [Control Mode: First Very-Low Temperature Starting Routine]

A first very-low temperature starting routine as a mode of the very-low temperature starting routine #Sub is shown in the flowchart in FIG. 7. In the first very-low temperature starting routine, the opening and closing timings of the intake valve Va are set through control performed by the intake-side valve opening-closing timing control mechanism VTa, and the opening and closing timings of the exhaust valve Vb are set through control performed by the exhaust-side valve opening-closing timing control mechanism VTb (steps #201 and #202).

In setting the opening and closing timings, an overlap in which EVC, which is the closing timing of the exhaust valve Vb, and IVO, which is the opening timing of the intake valve Va, are overlapped is set by matching IVO, which is the opening timing of the intake valve Va, with TDC, which is the top dead center of the piston 4, and setting EVC, which is the closing timing of the exhaust valve Vb, to an ATDC phase (in this control, the most retarded position), which is after TDC, as shown in the timing diagram in FIG. 8.

That is, in the first very-low temperature starting routine, control in which EVC, which is the closing timing of the exhaust valve Vb, is made different from TDC, which is the top dead center of the piston 4 of the combustion chamber, is performed in a situation where cranking is performed by the starter motor 15, and at a point in time when an initial combustion in one of the plurality of cylinders that is set to be the cylinder in which combustion is performed first is performed. A timing diagram of the specific control mode is shown in FIG. 8.

Next, cranking is started in response to driving of the starter motor 15, then cylinder determination is performed, and combustion in the combustion chambers in a set order by the combustion management portion 19 at a predetermined timing starts (steps #203 to #205).

After starting the combustion, if it is determined that the crankshaft 1 has been rotated by a predetermined amount based on detection by the shaft sensor 16, control to change the overlap to “0” (a specific example of the control to reduce the amount of the overlap) as shown in FIG. 9 is performed, and control to stop the starter motor 15 is performed (steps #206 and #207).

In this control, control to change the overlap to “0” at the timing when it is detected that the crankshaft 1 has been rotated by a predetermined amount (predetermined angle) is performed. Instead of this, however, control to change the amount of the overlap to “0” at the timing when it is detected that combustion has been performed in all four cylinders or a set number of cylinders may be performed, for example.

In the control to change the overlap to “0”, control in which EVC, which is the closing timing of the exhaust valve Vb, is matched with the IVO, which is the opening timing of the intake valve Va, (also matched with TDC), is performed through control performed by the exhaust-side valve opening-closing timing control mechanism VTb. Note that, in place of the control to change the amount of the overlap to “0”, a slight overlap may be set.

In this manner, when starting the engine E in a very-low temperature environment, by setting EVC, which is the closing timing of the exhaust valve Vb, at the most retarded position, EVC is set to an ATDC phase, which is after TDC, to create an overlap, thus making it possible to increase the temperature through internal EGR.

That is, in the engine E at a very low temperature, the cylinder inner surfaces are also in a low-temperature state. Accordingly, when fuel is injected by the injector 9, the fuel that comes into contact with the cylinder inner surface may form droplets, which attach to the cylinder inner surface, resulting in a reduction in the combustion performance.

In this respect, by creating an overlap, part of the high-temperature combustion gas can be taken into the combustion chamber via the exhaust valve Vb that is in the open state at the beginning of an intake stroke when combustion is performed. As a result, it is possible to prevent the fuel from forming droplets by bringing the high-temperature combustion gas into contact with the inner wall of the cylinder to increase the temperature of the inner wall. Consequently, the atomized state of the fuel injected by the injector 9 can be maintained, thus making it possible to perform satisfactory combustion from the beginning of combustion.

In particular, since the opening and closing timings of the intake valve Va are not changed in this control mode, the amount of taken-in air in an intake stroke is not changed, and it is possible to perform combustion that does not change the air-fuel ratio, for example. Furthermore, in the case of creating an overlap in an ATDC phase, as shown in FIG. 13, the number of revolutions (number of engine revolutions) of the crankshaft 1 reaches a set number of revolutions over time, and the number of engine revolutions also smoothly increases after subsequently changing the overlap to “0”, thus achieving smooth starting.

### [Modification of First Very-Low Temperature Starting Routine]

Note that, in the first very-low temperature starting routine, an overlap is created by setting EVC, which is the closing timing of the exhaust valve Vb, to an at ATDC phase, which is after TDC, which is a top dead center. Accordingly, it is also possible to, for example, set IVO, which is the opening timing of the intake valve Va, to a timing before TDC (BTDC phase), which is a top dead center, or to a timing after TDC (ATDC phase).

### [Control Mode: Second Very-Low Temperature Starting Routine]

A second very-low temperature starting routine as another mode of the very-low temperature starting routine #Sub is shown in the flowchart in FIG. 10. In the second very-low temperature starting routine, the opening and closing timings of the intake valve Va are set through control performed by the intake-side valve opening-closing timing control mechanism VTa, and the opening and closing timings of the exhaust valve Vb are set by control performed by the exhaust-side valve opening-closing timing control mechanism VTb (steps #301 and #302).

In setting the opening and closing timings, a negative overlap in which EVC, which is the closing timing of the exhaust valve Vb, and IVO, which is the opening timing of the intake valve Va, are overlapped is set by matching IVO, which is the opening timing of the intake valve Va, with TDC, which is the top dead center of the piston 4, and setting EVC, which is the closing timing, to a BTDC phase (in this control, the most advanced position), which is before TDC, as shown in the timing diagram in FIG. 11.

That is, in the second very-low temperature starting routine, control in which EVC, which is the closing timing of the exhaust valve Vb, is made different from TDC, which is the top dead center of the piston 4 of the combustion chamber, is performed in a situation where cranking is performed by the starter motor 15, and at a point in time when an initial combustion in one of the plurality of cylinders that is set to be the cylinder in which combustion is performed first is performed. A timing diagram of the specific control mode is shown in FIG. 11.

Next, cranking is started in response to driving of the starter motor 15, then cylinder determination is performed, and combustion in the combustion chambers in a set order by the combustion management portion 19 starts at a predetermined timing (steps #303 to #305).

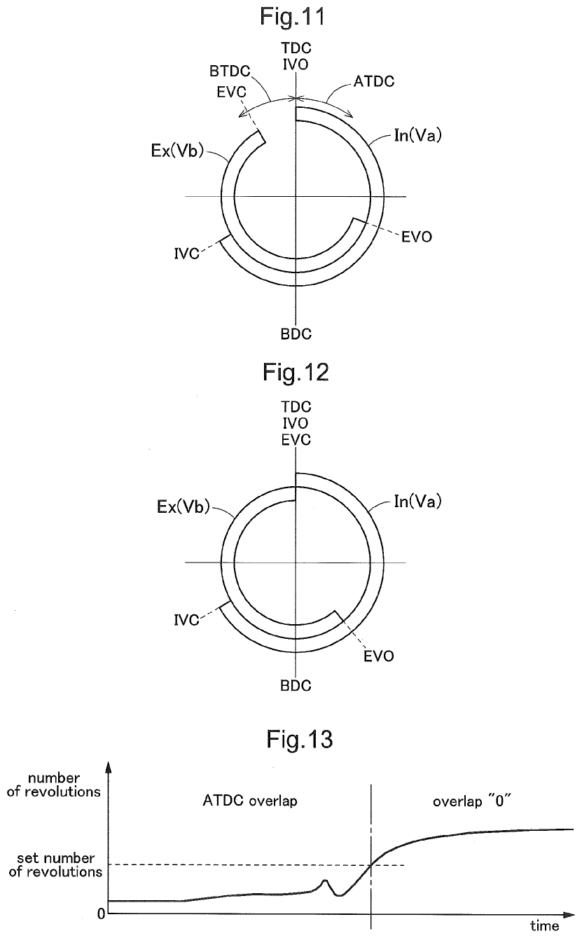

After starting the combustion, if it is determined that the crankshaft 1 has been rotated by a predetermined amount based on detection by the shaft sensor 16, control to change the negative overlap to “0” (a specific example of the control to reduce the amount of the negative overlap) as shown in FIG. 12, and control to stop the starter motor 15 are performed (steps #306 and #307).

In this control, control to change the negative overlap to “0” at the timing when it is detected that the crankshaft 1 has been rotated by a predetermined amount (predetermined angle) is performed. Instead of this, however, control to change the amount of the negative overlap to “0” at the timing when it is detected that combustion has been performed in all four cylinders or a set number of cylinders may be performed, for example.

In the control to change the negative overlap to “0”, control in which EVC, which is the closing timing of the exhaust valve Vb, is matched with the IVO, which is the opening timing of the intake valve Va, (also matched with TDC), is performed through control performed by the exhaust-side valve opening-closing timing control mechanism VTb. Note that, in place of the control to change the amount of negative overlap to “0”, a slight negative overlap may be set.

In this manner, when starting the engine E in a very-low temperature environment, by setting EVC, which is the closing timing of the exhaust valve Vb, at the most advanced angle position, EVC is set to a BTDC phase, which is before TDC, to create a negative overlap, thus making it possible to increase the temperature by trapping combustion gas in the combustion chamber.

That is, in the engine E at a very low temperature, the cylinder inner surface is also in a low-temperature state. Accordingly, when fuel is injected by the injector 9, fuel that has come into contact with the cylinder inner surface may form droplets, which attach the cylinder inner surface, resulting in a reduction in the combustion performance.

In this respect, by creating a negative overlap, combustion gas is trapped in the combustion chamber until the intake valve Va reaches IVO, which is an opening timing, in an intake stroke when combustion is performed, thus bringing the high-temperature combustion gas into contact with the cylinder inner surface of the combustion chamber to maintain the high-temperature state so as to increase the temperature. As a result, it is possible to prevent the fuel from forming droplets by increasing the time for which the high-temperature combustion gas is in contact with the inner wall of the cylinder to increase the temperature of the inner wall. Consequently, the atomized state of the fuel injected by the injector 9 can be maintained, thus making it possible to perform satisfactory combustion from the beginning of the combustion.

In particular, since the opening and closing timings of the intake valve Va are not changed in this control mode, the amount of taken-in air in an intake stroke is not changed, and it is possible to perform combustion that does not change the air-fuel ratio, for example.

### [Modification of Second Very-Low Temperature Starting Routine]

Note that, in the second very-low temperature starting routine, a negative overlap is created by setting EVC, which is the closing timing of the exhaust valve Vb, to a BTDC phase, which is before TDC, which is the top dead center. Accordingly, it is also possible to, for example, set IVO, which is the opening timing of the intake valve Va, to a timing before TDC (BTDC phase), which is a top dead center, or to timing after TDC (ATDC phase), which is a top dead center.

### INDUSTRIAL APPLICABILITY

The present invention is applicable to a control device for an internal combustion engine.

### REFERENCE SIGNS LIST

1: Crankshaft

4: Piston

14: Temperature sensor (environmental temperature sensor)

15: Starter motor

E: Engine (internal combustion engine)

M: Phase control motor (electric actuator)

Va: Intake valve

Vb: Exhaust valve

VTb: Valve opening-closing timing control mechanism

TDC: Top dead center

EVC: Closing timing of exhaust valve

IVO: Opening timing of intake valve

1. A control device for an internal combustion engine,
the internal combustion engine including: a plurality of cylinders each including a piston that reciprocally operates within a cylinder in association with rotation of a crankshaft, and an intake valve and an exhaust valve that open and close a combustion chamber in association with rotation of the crankshaft; a starter motor that drives and rotates the crankshaft; and a valve opening-closing timing control mechanism that sets opening and closing timings of the exhaust valve by driving an electric actuator, the control device comprising:
an environmental temperature sensor for detecting an environmental temperature around the internal combustion engine,
wherein, if the environmental temperature detected by the environmental temperature sensor is less than 10 degrees below freezing, the control device controls the electric actuator such that EVC, which is a closing timing of the exhaust valve, is made different from TDC, which is a top dead center of the piston in the combustion chamber, in a situation where cranking is performed by the starter motor, at a point in time when an initial combustion in one of the plurality of cylinders that is set to be the cylinder in which combustion is performed first is performed.

2. The control device for an internal combustion engine according to claim 1,
wherein, at a point in time when an initial combustion in one of the plurality of cylinders that is set to be the cylinder in which combustion is performed first is performed, an overlap in which the EVC and IVO, which is an opening timing of the intake valve, are overlapped is set by setting the EVC to an ATDC phase, which is after the TDC.

3. The control device for an internal combustion engine according to claim 2,
wherein an amount of the overlap is reduced after the number of revolutions of the crankshaft exceeds a predetermined set value.

4. The control device for an internal combustion engine according to claim 1,
wherein, at a point in time when an initial combustion in one of the plurality of cylinders that is set to be the cylinder in which combustion is performed first is performed, a negative overlap is set between the EVC and IVO, which is an opening timing of the intake valve, by setting the EVC to BTDC, which is before the TDC.

5. The control device for an internal combustion engine according to claim 4,
wherein an amount of the negative overlap is reduced after the number of revolutions of the crankshaft exceeds a predetermined value.

6. The control device for an internal combustion engine according to claim 1,
wherein, at a point in time when an initial combustion in one of the plurality of cylinders that is set to be the cylinder in which combustion is performed first is performed, the control device controls the electric actuator such that an overlap is set by retarding the EVC relative to IVO, which is an opening timing of the intake valve.
